(19) United States
(12) Patent Application Publication
(10) Pub. No.: US 2006/0241951 A1
(43) Pub. Date: Oct. 26, 2006

(54) Embedded Renewable Energy Certificates and System

(76) Inventors: Joshua David Cynamom, Chicago, IL (US); Hoyt Emmet Hudson, Chicago, IL (US)

Correspondence Address: JEFFREY FURR, 253 N. MAIN STREET, JOHNSTOWN, OH, 43031, US

(21) Appl. No.: 10/907,939

(22) Filed: Apr. 21, 2005

(51) Int. Cl. G06Q 99/00

(52) U.S. Cl. 705/1

(57) ABSTRACT

A novel means of marketing the environmental attributes of renewable energy or emissions credits. By selling these attributes together with the item whose energy or emissions impact they neutralize, Mainstay Energy offers to make more concrete and compelling the value these attributes represent. The sale may take the form of: lifetime energy use displacement, a fixed period displacement, or a fixed period with renewals. These attributes exist for all forms of energy, including electricity, natural gas, gasoline, diesel fuel, and others, and we would like to protect against others using this “embedded attributes” approach with any of these energy types or emissions reductions credits.

### BACKGROUND OF INVENTION

1. Field of the Invention

The present invention relates to techniques for using embedded renewable energy certificates or emissions credits, more particularly using embedded renewable energy certificates.

2. Description of Prior Art

The modern economy is driven by energy. There is evidence of this in the California power crisis and in expensive oil's impact on the global economy over the past six months. Increasingly, the world community is accepting that this energy use comes with a social cost—the pollution from generating and consuming energy. Companies have responded to this realization by offering several options to reduce the impact of our economic activities, including energy efficiency, air filters and pollution cleanup, and renewable resources which do not pollute to begin with.

U.S. Pat. No. 6,780,220 by Milbrath, et al. and issued on Aug. 24, 2004, is for a method for generating pollution credits while processing reactive metals. It discloses a method for generating pollution credits while processing molten magnesium, aluminum, lithium, and alloys of such metals by contacting the molten metal or alloy with a gaseous mixture comprising a fluorocarbon selected from the group consisting of perfluoroketones, hydrofluoroketones, and mixtures thereof.

U.S. Pat. No. 6,601,033 by Sowinski and issued on Jul. 29, 2003, is for a pollution credit method using electronic networks. It discloses a method and apparatus for effectuating commerce in claimant-driven individual pollution credits which allows gas utility consumers to claim pollution credit when reducing their pollution levels while employing energy efficiency measures, which has value. Such reduced pollution credit is given value by a third-party; thus, individuals, government agencies and related parties, working in concert with a third-party identify the need, establish ownership, calculate the pollution credit value, and create a new market that has economic value and environmental benefit.

U.S. Pat. No. 6,490,565 by Beldock and issued on Dec. 3, 2002, is for an environmental certification system and method. It discloses a data processing method for an environmental certification program which defines a plurality of predefined criteria which must be met by a participant in the program in order to be provided with a privilege of providing a certification mark for use on goods and in advertising materials of the participant. The data processing method tracks the compliance by the participant with the environmental certification program and further evaluates the continued certification of a participant in the program.

U.S. Pat. No. 6,058,379 by Odom, et al. and issued on May 2, 2000, is for a real-time network exchange with seller specified exchange parameters and interactive seller participation. It discloses a method for networked exchange that comprises 8 steps. Those steps are (1) specifying a mode of operations for an exchange; (2) identifying a commodity for the exchange; (3) listing information about the commodity; (4) accessing of the listing by a potential purchaser; (5) accessing the network-based exchange by the potential purchaser; (6) processing information generated by the potential purchaser, the information comprising a negotiation; (7) concluding the negotiation; and, (8) clearing the concluded negotiation.

U.S. Pat. No. 5,873,071 by Ferstenberg, et al. and issued on Feb. 16, 1999, is for a computer method and system for intermediated exchange of commodities. It discloses an invention which includes software processes distributed on one or more computer systems that exchange messages in order to facilitate an intermediated exchange of financial commodities between a plurality of participants.

United States Patent Application 20040230443 by McMorris, et al. and published on Nov. 18, 2004, is for a system and method of creating, aggregating, and transferring environmental emisssion reductions. It discloses an integrated, holistic methodology for enabling a systematic creation, aggregation, verification, registration, storage, transfer/sale, and retirement of environmental emission removal units that provides a control and management system complementing the use of sound foundational science to qualify and quantify environmental emission reductions and removals, and provides the framework for accurate data collection, storage, and processing.

United States Patent Application 20040181421 by Bjelogrlic, et al. and published on Sep. 16, 2004, is for an optimized transmission and load security constrained unit commitment dispatch using linear programming for electricity markets. It discloses a method for optimizing security constrained unit commitment in the day ahead wholesale electricity market using mixed integer linear programming techniques. The wholesale electricity market uniquely requires the submission of offers to supply energy and ancillary services at stated prices, as well as bids to purchase energy, and known operating and security constraints. The present invention addresses the above noted needs by providing a SCUC engine to support and implement the requirements via a computer system implementation.

United States Patent Application 20040138949 by Darnton, et al. and published on Jul. 15, 2004, is for sponsored appliances. It discloses a method of creating a sponsored appliance. The method comprises the steps of creating a sponsored relationship between an appliance sponsor and an appliance seller, incorporating sponsorship material into the appliance, and providing the sponsored appliance with purchase incentive as a result of the sponsorship.

United States Patent Application 20040093225 by Bedner, et al. and published on May 13, 2004, is for a method and system for providing recycling information. It discloses a method and system for providing recycling information is disclosed. Through the use of the method and system in accordance with the present invention, the likelihood that a consumer will have the information necessary to effectively recycle a product is increased.

United States Patent Application 20040015433 by Johnson, et al. and published on Jan. 22, 2004, is for a bidding for energy supply to resellers and their customers. It discloses an auction service that stimulates competition between energy suppliers (i.e., electric power or natural gas). A bidding moderator (Moderator) receives offers from competing suppliers specifying the economic terms each is willing to offer to resellers or customers of resellers for estimated quantities of electric power or gas supply (separate auctions).

United States Patent Application 20030101062 by Taber and published on May 29, 2003, is for a large scale procurement of energy efficiency resources. It discloses a variation of the ESCO business model which incorporates elements of a large scale procurement of energy efficiency resources on behalf of a number of host customers. The resulting program greatly increases the cost-efficiency of the process and, therefore, it also increases the economic benefits to the participating host customers.

United States Patent Application 20020062594 by Erickson and published on May 30, 2002, is for a resource conservation method. It discloses a resource conservation method, including commodity market exchanges in furtherance thereof. Carbon dioxide is acquired from at least one carbon dioxide source for recycling the carbon dioxide. Valuable consideration is received for the acquisition of the carbon dioxide, with carbon dioxide provided, for valuable consideration, from a supply of the acquired carbon dioxide to growing plants for adsorption thereby in furtherance of photosynthesis. Water generally consumed by the growing plants is reduced and thus conserved, whereby financial incentives motivate carbon dioxide recycling and water conservation, thereby bringing arid land into productive use.

United States Patent Application 20010041988 by Lin and published on Nov. 15, 2001, is for a customer-renders-seller issued incentive-voucher to after-sales service providers to enhance service quality. It discloses a method for transferring electronic vouchers over a network system for defining and rewarding an after-sales service and customer care activity. In a preferred embodiment, the method further includes a step of transferring an incentive electronic voucher for payment of an assessment of customer satisfaction.

There is still room for improvement in the art.

### SUMMARY OF INVENTION

A novel means of marketing the environmental attributes of renewable energy or emissions credits. By selling these attributes together with the item whose energy or emissions impact they neutralize, the current invention offers to make more concrete and compelling the value these attributes represent. The sale may take the form of lifetime energy use displacement, a fixed period displacement, or a fixed period with renewals. These attributes exist for all forms of energy, including electricity, natural gas, gasoline, diesel fuel, and others, and we would like to protect against others using this “embedded attributes” approach with any of these energy types or emissions reductions credits.

The system is more efficient, effective, accurate, and functional than the current art.

### BRIEF DESCRIPTION OF DRAWINGS

Without restricting the full scope of this invention, the preferred form of this invention is illustrated in the following drawings:

FIG. 1 displays the Status Quo: Brown product, brown electrical energy;

FIG. 2 displays the Status Quo: Brown transportation product, brown transportation energy;

FIG. 3 displays the Status Quo: Brown electrical product, green non-REC power;

FIG. 4 displays the Status Quo: Brown electrical product, green RECs purchased;

FIG. 5 displays the Status Quo: Brown transportation fuel, ERUs purchased;

FIG. 6 displays the New Transaction of the current invention: Green Product, Brown Electricity;

FIG. 7 displays the New Transaction of the current invention: Brown Transportation Fuel, Product with Bundled ERUs;

FIG. 8 shows the use of paper certificates;

FIG. 9 shows the use of electronic certificates and system; and

FIG. 10 show the use of the certificates on packaging.

### DETAILED DESCRIPTION

The following description is demonstrative in nature and is not intended to limit the scope of the invention or its application of uses.

The modern economy is driven by energy. There is evidence of this in the California power crisis and in expensive oil's impact on the global economy over the years. Increasingly, the world community is accepting that this energy use comes with a social cost—the pollution from generating and consuming energy. Companies have responded to this realization by offering several options to reduce the impact of our economic activities, including energy efficiency, air filters and pollution cleanup, and renewable resources which do not pollute to begin with.

One way interested parties can exchange these items of value is to buy the renewable attributes, or sustainability characteristics, of the energy efficiency or renewable energy. Another is through the trading of emissions offsets. This exchange is facilitated through Renewable Energy Certificates (RECs) 100, a.k.a. Tradable Renewable Certificates (TRCs), or Green Tags as well as through emissions credits, a.k.a. Emissions Reductions Units (ERUs).

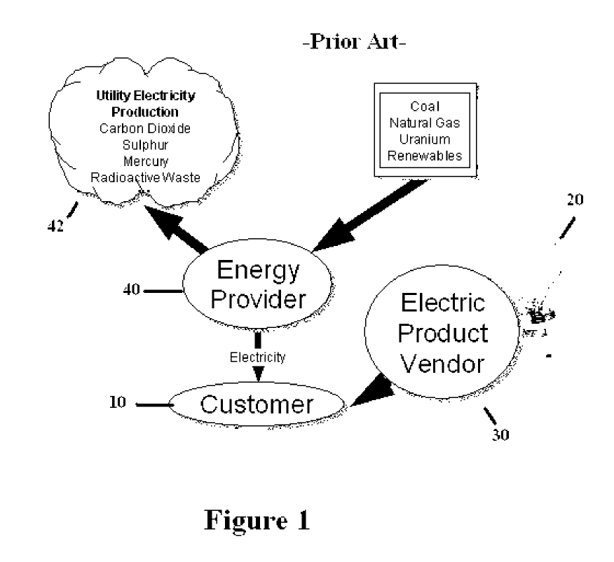

As shown in FIG. 1, in the conventional example, the customer 10 purchases an energy consuming product 20 (like a blender) from a vendor 30. He then purchases energy from an energy provider 40. In generating this electrical energy, the customer 10 consumes a finite, non-replenishing resource, and generates pollution 42.

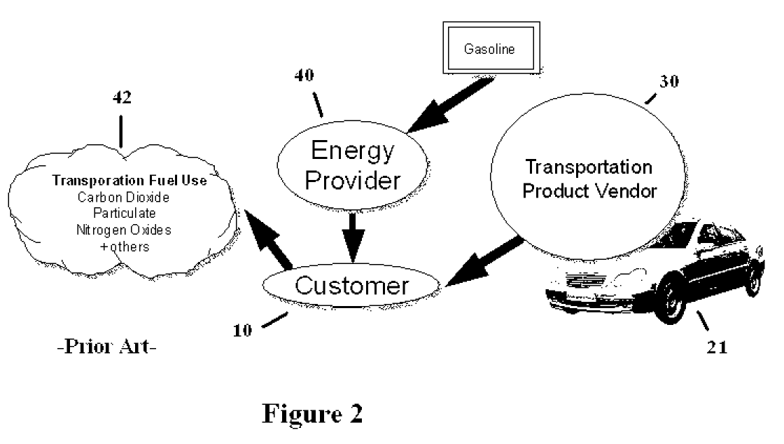

In the conventional example shown in FIG. 2, the customer 10 purchases an energy consuming transportation product 21 (like a car) from a vendor 30. He then purchases fuel from an energy provider 40. In powering this vehicle, the customer 10 consumes a finite, non-replenishing resource and generates pollution 42

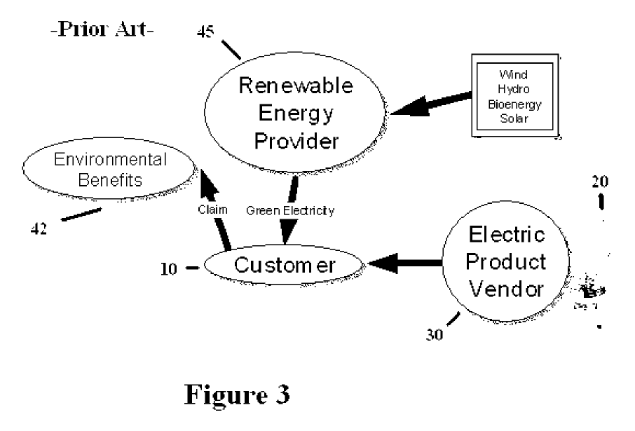

In one example of a “traditional” green power transaction as shown in FIG. 3, the customer 10 purchases an energy consuming product 20 from a vendor 30. He then purchases energy from a renewable energy provider 45. The customer 10 makes environmental claims based upon the consumption of renewable energy.

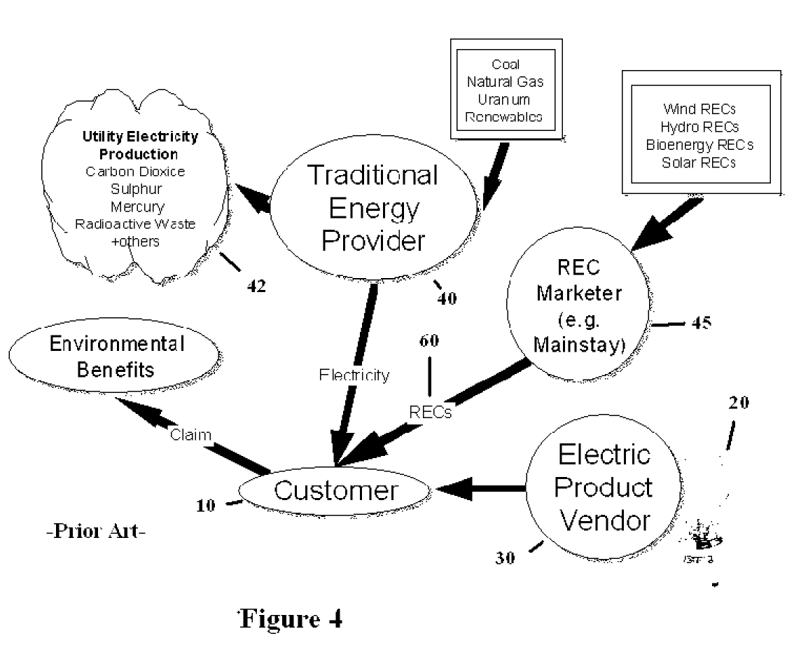

In another example of a “traditional” green power transaction as shown in FIG. 4, the customer 10 purchases an energy consuming product 20 from a vendor 30. He then purchases RECs 60 from a renewable energy certificate provider 70. The customer 10 makes environmental claims based upon the consumption of renewable energy, when the brown electricity and green RECs 60 are re-aggregated at the point of energy consumption.

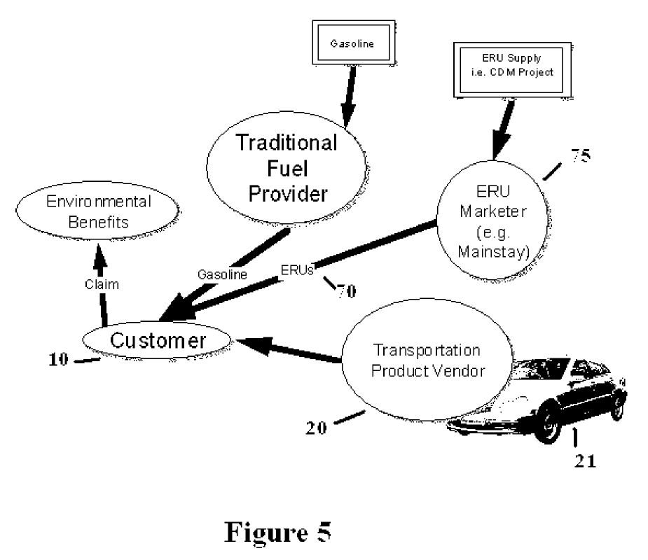

In another example of a “traditional” transportation emissions offset as shown in FIG. 5, the customer 10 purchases a vehicle 21 that consumes transportation fuel. He then purchases Emissions Reductions Units (ERUs) 65 from an ERU provider 75. The customer 10 makes environmental claims based upon a lower emissions profile, when the transportation fuel and emissions offsets are re-aggregated at the point of energy consumption.

The current invention is an innovation in marketing these RECs 60 and ERUs 65. Typically, a facility generating renewable energy will unbundle it: renewable energy separates into regular energy plus RECs 60. The company can then use (or sell) the energy, and market the RECs 60. One problem with this approach is convincing a consumer 10 of the value (or even the meaning) of a REC 60. As an abstraction, the REC's value is difficult to quantify or appreciate.

By attaching these RECs 60 or ERUs 70 to the items 80 using the energy, the inventor will clarify what these credits mean and how they benefit the environment. It is the way that combining the attributes increases their marketability through clarifying their contribution to improving our energy use that makes this approach so useful.

These sales can come in one of several forms, protection for each of which is being sought. To illustrate, here are some examples.

Lifetime Certificates: This is an embedded certificate 100 covering the total energy usage of a given product. This will typically be a smaller product, although it does not need to be. A compact fluorescent light bulb, for example, may use 20 watts of power while producing the same light as a conventional 75-watt bulb. It will last for approximately 10,000 hours. So, over its lifetime, it will use approximately 200,000 watt-hours of energy (equivalent to ⅕ of a REC 60). This is a good option for lifetime RECs 60. A company could sell the bulbs to embed RECs in the bulb, rendering the bulb 100% neutral to the environment.

Fixed-period Certificates: In the same way that a warranty may last for two years, even though the item it covers lasts five to ten years, the current invention can provide the same type of approach for an energy consuming item. A refrigerator, as an example, may use electricity equivalent to approximately 1 REC 60 each year. To purchase lifetime RECs 60 would add a burdensome cost to that of the refrigerator, but to purchase one or two years would be affordable. In this case, it would want to offer a customer the option of offsetting only a preliminary period of energy use, encompassing part of the product's lifetime energy use.

Fixed-period Certificates with Renewals: As a variation of Fixed-period Certificates 100, the current invention would like to offer fixed period certificates with automatic (or optional) renewal. As another example for this, the customer 10 could have a natural gas furnace. The customer 10 registers the furnace with a company which will periodically renew their contract for the RECs 60 to run it.

The current invention also can have Production Certificates 100 which are a variation where instead of bundling the roll-forward use certificates that will be used by an object in the future, the system bundles all of the credits representing the energy that was used in its production. For example, an automobile could be sold where renewable energy credits were bundled with the sale to account for the energy used along some or all of the stages of its manufacturing.

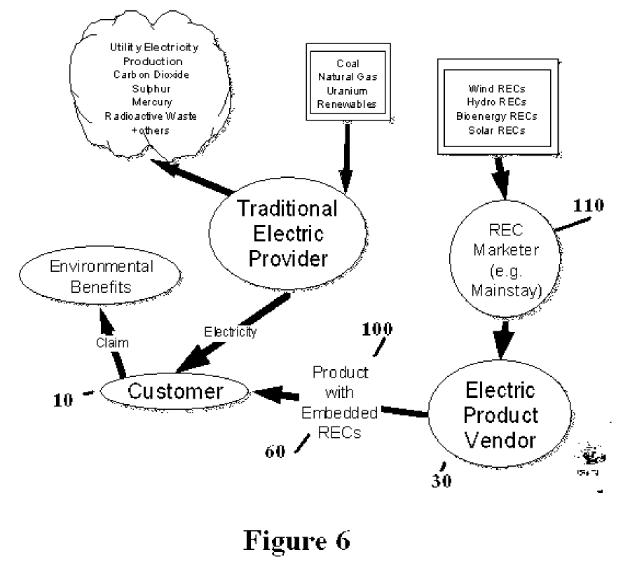

FIG. 6 displays the novel green power transaction of the current invention, the manufacturer or marketer 90 of an energy consuming product 21 (like a blender) purchases renewable energy certificates 100 from a REC provider 110 The electric product and the bundled RECs 60 are sold as a package to a customer 10. The customer 10 makes environmental claims based upon the consumption of renewable energy, when the brown electricity and green RECs 60 are re-aggregated at the point of energy consumption.

What makes the embedded certificates so attractive is that it opens the market to an entirely new brand of customer. The innovation is not in offsetting energy consumption, or even in offsetting consumption from a particular activity or item. The magic is that procuring the renewable energy is completely “push” rather than “pull,” insofar as the customer is presented with renewable energy certificates 100, and there is no administration—just a simple choice: “yes” or “no.”

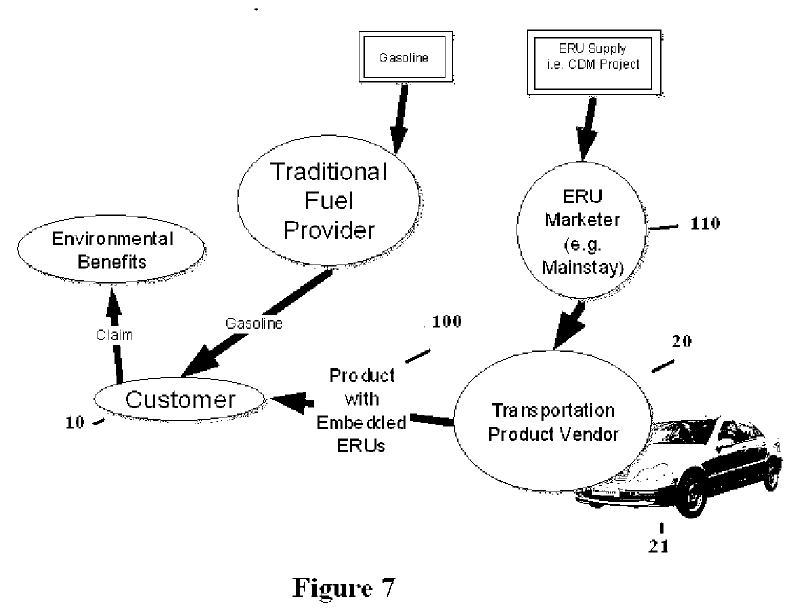

In the novel emissions transaction of the current invention as shown in FIG. 7, the manufacturer or marketer of a transportation product (like a car) purchases Emissions Reductions Units from an ERU provider. The vehicle and the bundled ERUs are sold as a package to a customer 10. The customer 10 makes environmental claims based upon a lower emissions profile, when the transportation fuel and emissions offsets are re-aggregated at the point of energy consumption.

Operation

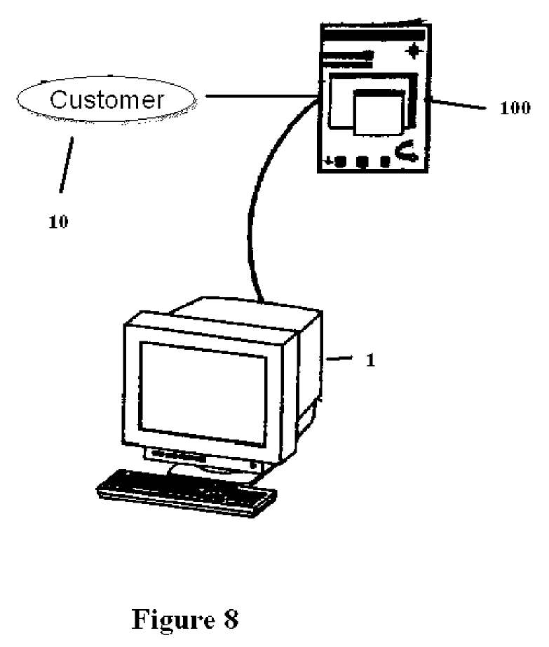

The certificates 100 can be created through a number of means. As shown in FIG. 8, these certificates 100 can be actual printed documents. A system 1 residing on a standard PC or printing station will calculate the renewable energy unit and print that onto a standard certification paper 100. This paper can be presented and sold to the consumer 10.

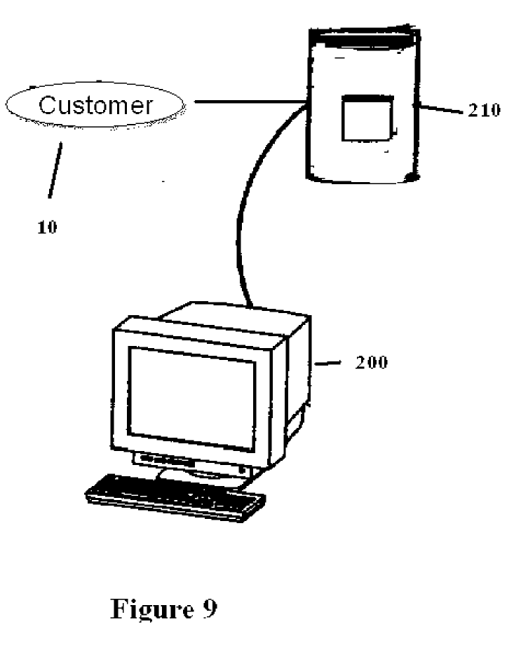

As shown in FIG. 9, the certificates 100 can be an electronic document or file which can be stored on a computer processing system 200 or database 210. The electronic certifications can be transferred electronically to the consumer 10 from the vender 30 or even from a vendor 30 to another vendor 30.

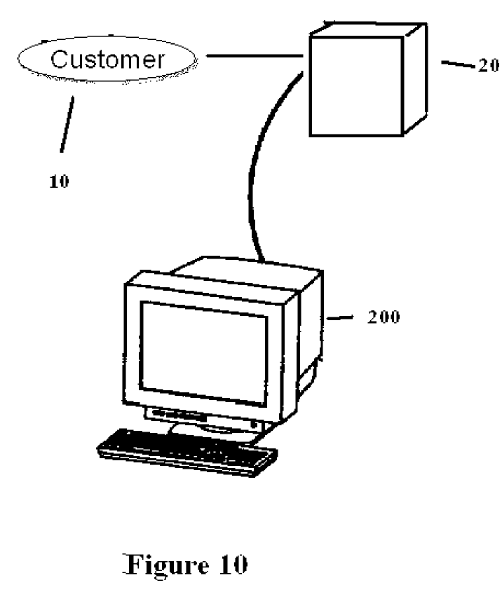

FIG. 10 displays the certificates being part of the packaging 205 of a product. The certificate 10 is displayed on the product showing the customer the energy savings of the product.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, and assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A device use to for marketing the environmental attributes of renewable energy or emissions credits comprising:
a credit certificate that is tied to an item that uses energy.

2. The device as described in claim 1, where said certificates are for Renewable Energy Certificates.

3. The device as described in claim 1, where said certificates are for Emissions Reductions Units.

4. The device as described in claim 1, where said certificates cover the total lifetime energy usage of a given product.

5. The device as described in claim 1, where said certificates cover the total energy usage of a given product for a fixed-period.

6. The device as described in claim 1, where said certificates cover the total energy usage of a given product for a Fixed-period Certificate with an optional renewal period.

7. The device as described in claim 1, where the seller of a product purchases said certificates to sell with a product.

8. The device as described in claim 1, where the certificate is printed.

9. The device as described in claim 1, where the certificate is in an electronic form.

10. The device as described in claim 1, where the certificate is on the products packaging.

11. A method for marketing the environmental attributes of renewable energy or emissions credits comprising:
a credit certificate that is tied to an item that uses energy.

12. The method as described in claim 11, where said certificates are for Renewable Energy Certificates.

13. The method as described in claim 11, where said certificates are for Emissions Reductions Units.

14. The method as described in claim 11, where said certificates cover the total lifetime energy usage of a given product.

15. The method as described in claim 11, where said certificates cover the total energy usage of a given product for a fixed-period.

16. The method as described in claim 11, where said certificates cover the total energy usage of a given product for a Fixed-period Certificate with an optional renewal period.

17. The method as described in claim 11, where the seller of a product purchases said certificates to sell with a product.

18. The method as described in claim 11, where the certificate is printed.

19. The method as described in claim 11, where the certificate is in an electronic form.

20. The method as described in claim 11, where the certificate is on the products packaging.
